(19) United States
(12) Patent Application Publication
(10) Pub. No.: US 2007/0097033 A1
(43) Pub. Date: May 3, 2007

(54) Driving of plasma display device

(76) Inventors: Sang-Shin Kwak, Yongin-si (KR); Hak-Cheol Yang, Yongin-si (KR); Joon-Yeon Kim, Yongin-si (KR); Yong-jin Jeong, Yongin-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/584,829

(22) Filed: Oct. 23, 2006

(30) Foreign Application Priority Data
Nov. 2, 2005 (KR) 10-2005-0104204

(51) Int. Cl. G09G 3/28

(52) U.S. Cl. 345/68

(57) ABSTRACT

A circuit for supplying voltages to an electrode of a plasma display device is disclosed. The circuit includes an inductor connected to the electrode, a first capacitor and a second capacitor serially connected to the first capacitor. The circuit selectively forms certain paths to provide pulses to the electrode to sustain plasma discharges. The circuit provides pulses by increasing the potential of the electrode from a first voltage to a second voltage, maintaining the potential at about the second voltage during a first period, increasing the potential from about the second voltage to a third voltage, maintaining the potential at about the third voltage during a second period, decreasing the potential from about the third voltage to about the first voltage, and maintaining the potential at about the first voltage during a third period. Increasing the potential from the first to second voltages involves supplying energy stored in the first and second capacitors to the electrode via the inductor. Increasing the potential from the second to third voltages involves supplying energy stored in the first and second capacitors to the first electrodes via the inductor and further involves supplying energy from a power source to the electrode via the inductor.

### CROSS-REFERENCE TO RELATED APPLICATION

This application claims priority to and the benefit of Korean Patent Application No. 10-2005-0104204 filed in the Korean Intellectual Property Office on Nov. 2, 2005, the entire content of which is incorporated herein by reference.

### BACKGROUND OF THE INVENTION

1. Field of the Invention

The present invention relates to a plasma display device. More particularly, the present invention relates to driving of a plasma display device.

2. Description of the Related Art

A plasma display device is a flat panel display that uses plasma generated by a gas discharge process to display characters or images. To implement variations in brightness of image display, the time for displaying a single frame is divided into a plurality of time segment called “subfields”. In each subfield, cells to be turned on for emitting light are selected by a short plasma discharge called “address discharge”. Still in each subfield, these selected cells are then discharged (called “sustain discharge”) during a sustain period following the address period so as to emit light.

Typically a high-level voltage and a low-level voltage are alternately applied to an electrode performing the sustain discharge during the sustain period. One transistor is connected between the electrode and a power source for the high-level voltage, and another transistor is connected between the electrode and a power source for the low-level voltage. When the high-level voltage or the low-level voltage is applied to the electrode, one of the two transistors is turned off, and the high-level and low-level voltages are respectively applied to a drain and a source of the turned-off transistor. Therefore, the withstand voltage of the transistor should be greater than the difference between the high-level and low-level voltages. Since the difference between the high-level and low-level voltages used in the sustain discharge is large, the transistor should have a high withstand voltage. However, the transistor having such a high withstand voltage may be expensive and increase the production costs of the plasma display devices.

The above information disclosed in this Background section is only for the understanding of the background of the invention. The foregoing information does not constitute an admission of prior art.

### SUMMARY OF THE INVENTION

One aspect of the invention provides a plasma display device comprising an electrode and a circuit for supplying voltages to the electrode. The circuit comprises: a first capacitor comprising a first end and a second end, a second capacitor comprising a first end and a second end, wherein the second end of the second capacitor is electrically connected to the first end of the first capacitor, an inductor comprising a first end and a second end, wherein the first end of the inductor is electrically connected to the electrode, a first switch electrically connected between the second end of the first capacitor and the second end of the inductor, a second switch electrically connected between the second end of the second capacitor and the second end of the inductor, a third switch electrically connected between the second end of the first capacitor and the electrode, and a fourth switch electrically connected between the electrode and the first end of the second capacitor, wherein the first end of the second capacitor is selectively connected to a first power source configured to supply a first voltage or a second power source configured to supply a second voltage.

In the foregoing plasma display device, the circuit may further comprise: a fifth switch electrically connected between the first power source and the first end of the second capacitor; and a sixth switch electrically connected between the second power source and the first end of the second capacitor; wherein the circuit may be configured to selectively form a charging path that electrically connects the first power source to the first end of the first capacitor, and may be to charge the first and second capacitors. The charging path may comprise a first diode having an anode electrically connected to the first power source and a cathode electrically connected to the second end of the first capacitor. Each of the first switch and the second switch may comprise a transistor having a body diode, wherein the circuit may further comprise a second diode serially connected to the first switch and a third diode serially connected to the second switch, and wherein the second diode and the body diode of the first switch may be connected in opposite directions, and the third diode and the body diode of the second switch may be connected in opposite directions.

The foregoing plasma display device may further comprise: a fourth diode having an anode electrically connected to the second end of the inductor and a cathode electrically connected to the second end of the first capacitor; and a fifth diode having a cathode electrically connected to the second end of the inductor and an anode electrically connected to the first end of the second capacitor. The plasma display device may further comprise a controller configured to cause to: turn the fourth and sixth switches on during a first period, turn the first and sixth switches on during a second period, turn the third and sixth switches on during a third period, turn the first and fifth switches on during a fourth period, turn the third and fifth switches on during a fifth period, turn the second and fifth switches on during a sixth period, turn the third and sixth switches on during a seventh period, and turn the second and sixth switches on during an eighth period. The first and second capacitors may have substantially the same capacitance. The second voltage may be a ground voltage, and wherein the first voltage may be higher than the second voltage. The first voltage may be a ground voltage, and wherein the second voltage may be lower than the first voltage.

Another aspect of the invention provides a method of driving a plasma display device. The method comprising: providing a plasma display device comprising a first electrode, a second electrode, a first capacitor, a second capacitor and an inductor, wherein the second capacitor is serially connected to the first capacitor; first increasing the potential of the first electrode from a first voltage to a second voltage; first maintaining the potential at about the second voltage during a first period; second increasing the potential from about the second voltage to a third voltage; second maintaining the potential at about the third voltage during a second period; decreasing the potential from about the third voltage to about the first voltage; and third maintaining the potential at about the first voltage during a third period. In the method, first increasing comprises supplying energy stored in the first and second capacitors to the first electrode via the inductor, wherein second increasing comprises supplying energy stored in the first and second capacitors to the first electrodes via the inductor, and wherein second increasing may further comprise supplying energy from a power source to the first electrode via the inductor.

In the foregoing method, decreasing may comprise: first decreasing the potential from about the third voltage to a fourth voltage; fourth maintaining the potential at about the fourth voltage for during a fourth period; and second decreasing the potential form about the fourth voltage to about the first voltage; wherein first decreasing may comprise releasing energy stored at the first electrode to a common node located between the first and second capacitors via the inductor and further to the power source via the inductor; wherein second decreasing may comprise releasing energy stored at the first electrode to the common node via the inductor. The method may further comprise charging the first and second capacitors using the power source during the third period. The inductor may retain a first residual energy after first increasing and a second residual energy after second increasing, wherein the method may further comprise: releasing the first residual energy to the first and second capacitors during the first period; and releasing the second residual energy to the first and second capacitors during the second period.

The foregoing method may further comprise: maintaining the potential of the second electrode at about the first voltage during the second period; and maintaining the potential of the second electrode at about the third voltage during the third period. The second voltage may be substantially the same as the fourth voltage. The difference between the third voltage and the fourth voltage may be about half of the difference between the third voltage and the first voltage. The method may further comprise repeating a sequence of actions, wherein the sequence may comprise first increasing, first maintaining, second increasing, second maintaining, decreasing, and third maintaining.

Still another aspect of the invention provides an apparatus for driving a plasma display device having an electrode. The apparatus comprises: an inductor configured to electrically connected to an electrode of a plasma display device; a first capacitor; a second capacitor serially connected to the first capacitor; and circuits configured to selectively form a first path and a second path; wherein the first path is to supply energy stored in the first and second capacitors to the electrode via the inductor so as to increase the potential of the electrode during a first period; wherein the second path is to release energy from the electrode to a common node located between the first and second capacitors via the inductor so as to decrease the potential of the electrode for a second period following the first period. The second capacitor may comprise a first end and a second end, wherein the second end of the second capacitor may be connected to the common node, wherein the circuits may be further configured to selectively connect a first power source or a second power source to the first end of the second capacitor, and wherein the first and second power sources may be configured to supply different voltages. A further aspect of the invention provides a plasma display device comprising the foregoing apparatus. One exemplary embodiment of the present invention provides a plasma display device for using a transistor having a relatively low withstand voltage in a sustain discharge circuit, and a driving apparatus and a driving method thereof.

An exemplary plasma display device according to an embodiment of the present invention includes a plurality of first electrodes, a first transistor, a second transistor, a first capacitor, a second capacitor, a charging path, an inductor, a third transistor, a fourth transistor, a fifth transistor, and a sixth transistor. The first transistor has a first end electrically coupled to a first power source that supplies a first voltage. The second transistor has a first end coupled to a second end of the first transistor and a second end coupled to a second power source that supplies a second voltage. The first capacitor charges a third voltage, and has a first end electrically coupled to a node of the first transistor and the second transistor. The second capacitor charges a fourth voltage, and has a first end electrically coupled to the second end of the first capacitor. The charging path is electrically coupled between the first power source and the second end of the second transistor. The inductor has a first end electrically coupled to the plurality of first electrodes. The third transistor is electrically coupled between the second end of the second capacitor and a second end of the inductor. The fourth transistor is electrically coupled between the second end of the first capacitor and the second end of the inductor. The fifth transistor is electrically coupled between the second end of the second capacitor and the plurality of first electrodes. The sixth transistor is electrically coupled between the plurality of first electrodes and the first end of the first transistor.

The plasma display device further includes a controller. The controller sets the second and sixth transistors to be turned on during a first period, the second and third transistors to be turned on during a second period, the second and fifth transistors to be turned on during a third period, the first and third transistors to be turned on during a fourth period, the first and fifth transistors to be turned on during a fifth period, the first and fourth transistors to be turned on during a sixth period, the second and fifth transistors to be turned on during a seventh period, and the second and fourth transistors to be turned on during an eighth period.

An exemplary driving method according to another embodiment of the present invention drives a plasma display device having a first electrode and a second electrode. In the driving method, a voltage of the first electrode is increased by applying energy stored in a first capacitor that charges a first voltage and a second capacitor that charges a second voltage to the first electrode through an inductor which is electrically coupled to the first electrode. A third voltage that corresponds to a sum of the first and second voltages is applied to the first electrode through the first and second capacitors.

The voltage of the first electrode is increased by applying energy stored in a first power source, the first capacitor, and the second capacitor to the first electrode through the inductor, the first power source supplying a fourth voltage. A fifth voltage that corresponds to a sum of the third and fourth voltages is applied to the first electrode through the first power source, the first capacitor, and the second capacitor. The voltage of the first electrode is decreased by recovering the energy stored in the first electrode to the first capacitor and the first power source through the inductor. A sixth voltage that is lower than the fourth voltage is applied to the first electrode. An exemplary driving apparatus according to another embodiment of the present invention drives a plasma display device including a first electrode and a second electrode.

The driving apparatus includes an inductor, a first capacitor, a second capacitor, a first transistor, a second transistor, a third transistor, a fourth transistor, and a switch. The inductor has a first end electrically coupled to the first electrode. The first capacitor charges a first voltage. The second capacitor charges a second voltage, and has a first end electrically coupled to a first end of the first capacitor. The first transistor is electrically coupled between a second end of the first capacitor and the first electrode. The second transistor is electrically coupled between a second end of the second capacitor and the first electrode. The third transistor is electrically coupled between the second end of the first capacitor and a second end of the inductor. The fourth transistor is electrically coupled between the first end of the second capacitor and the second end of the inductor. The switch selectively applies a third voltage and a fourth voltage that is lower than the third voltage to the second end of the second capacitor. The third transistor is turned on while the fourth voltage is applied to the second end of the second capacitor and thus a voltage of the first electrode is increased from the fourth voltage to a fifth voltage which corresponds to a sum of the fourth voltage, the first voltage, and the second voltage.

The first transistor is turned on while the fourth voltage is applied to the second end of the second capacitor and thus the fifth voltage is applied to the first electrode. The third transistor is turned on while the third voltage is applied to the second end of the second capacitor and thus the voltage of the first electrode is increased from the fifth voltage to a sixth voltage that corresponds to a sum of the first voltage, the second voltage, and the third voltage. The fourth transistor is turned on while the third voltage is applied to the second end of the second capacitor and thus the voltage of the first electrode is decreased from the sixth voltage to the fifth voltage. The first transistor is turned on while the fourth voltage is applied to the second end of the second capacitor and thus the fifth voltage is applied to the first electrode. The fourth transistor is turned on while the fourth voltage is applied to the second end of the second capacitor and thus the voltage of the first electrode is decreased from the fifth voltage to the fourth voltage. The second transistor is turned on while the fourth voltage is applied to the second end of the second capacitor and thus the fourth voltage is applied to the first electrode.

### BRIEF DESCRIPTION OF THE DRAWINGS

FIG. 1 is a schematic view of a plasma display device according to an embodiment.

FIG. 2 illustrates sustain pulses according to an embodiment.

FIG. 3 is a circuit diagram for generating sustain discharge pulses of FIG. 2 according to an embodiment.

FIG. 4 is a signal timing profile for the circuit of FIG. 3 according to an embodiment.

FIG. 5A to FIG. 5H show operations of the circuit of FIG. 3 in accordance with the signal time of FIG. 4.

FIG. 6 illustrates sustain discharge pulses according to another embodiment.

FIG. 7 is a circuit diagram for generating sustain discharge pulses of FIG. 6 according to an embodiment.

### DETAILED DESCRIPTION OF THE EMBODIMENTS

In the following detailed description, only certain exemplary embodiments of the present invention are described. As those skilled in the art would realize, the described embodiments may be modified in various different ways, all without departing from the spirit or scope of the present invention. For the sake of convenience, descriptions of functionally similar parts or elements are not repeated in different embodiments, and like numerals are used to refer to like parts and elements.

Throughout this specification and the claims, unless explicitly stated to the contrary, the words “comprise” and “include” will be understood to mean inclusion of stated elements and not exclusion of any other elements. In addition, throughout this specification and the claims which follow, the expression of maintaining a voltage at a given level implies that a slight and non-significant variation of a potential difference between two specific points may be acceptable within an allowable range with respect to design and function. The variation also may be accepted when it is caused by parasitic components that are practically ignored by skilled artisans. In addition, since a threshold voltage of a semiconductor element (e.g., a transistor or a diode) is significantly lower than a discharge voltage, the threshold voltage is approximated to 0V.

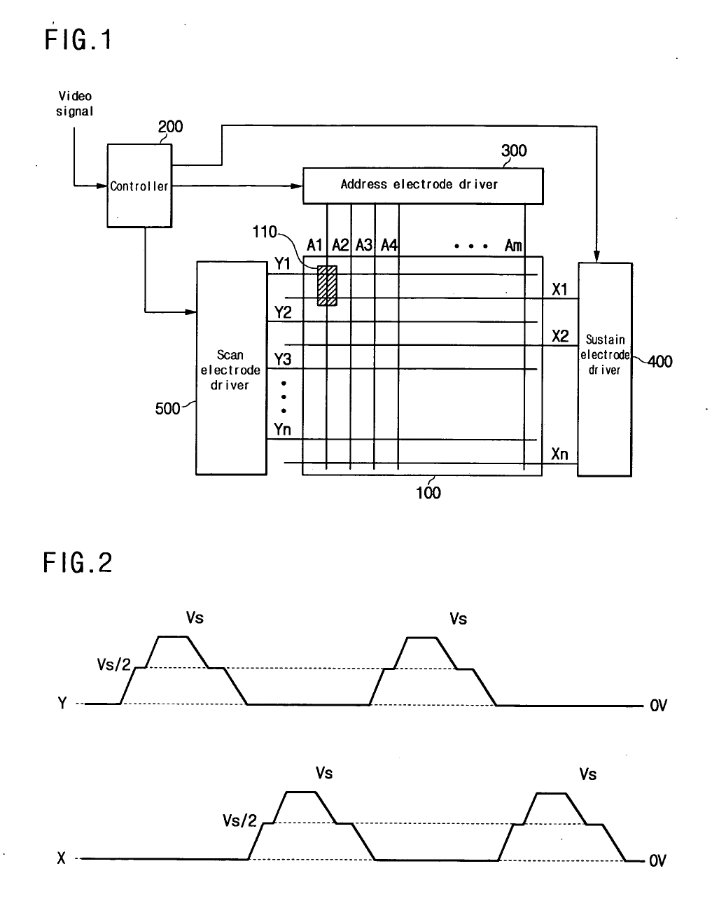

FIG. 1 is a schematic view of a plasma display device according to an exemplary embodiment of the present invention, and FIG. 2 illustrates a sustain pulse according to a first exemplary embodiment of the present invention. As shown in FIG. 1, the plasma display device includes a plasma display panel (PDP) 100, a controller 200, an address electrode driver 300 (hereinafter referred to as “A electrode driver), a sustain electrode driver 400 (hereinafter referred to as “X electrode driver”), and scan electrode driver 500 (hereinafter referred to as “Y electrode driver”).

The PDP 100 includes a plurality of address electrodes A1 to Am (hereinafter referred to as “A electrodes”) extending in a column direction, a plurality of sustain electrodes X1 to Xn (hereinafter referred to as “X electrodes”) extending in a row direction, and a plurality of scan electrodes Y1 to Yn (hereinafter referred to as “Y electrodes”) also extending in the row direction. The respective X electrodes X1 to Xn are alternately formed with respect to the Y electrodes Y1 to Yn, and the Y electrodes Y1 to Yn and the X electrodes X1 to Xn cross the A electrodes A1 to Am. Here, discharge cells 110 are formed where each of the A electrodes A1 to Am crosses each of the X electrodes X1 to Xn and the Y electrodes Y1 to Yn form discharge cells 110.

The controller 200 receives external video signals and outputs driving control signals, and divides the time for a single frame into a plurality of subfields (time segments), each of which has a luminance weight primarily based on the length of each subfield. Each subfield includes an address period and a sustain period. The A electrode, X electrode, and Y electrode drivers 300, 400, and 500 respectively apply driving voltages to the A electrodes A1 to Am, the X electrodes X1 to Xn, and the Y electrodes Y1 to Yn according to the driving control signals from the controller 200.

In more detail, in the address period of each subfield, the A electrode, X electrode, and Y electrode drivers 300, 400, and 500 select turn-on cells and turn-off cells among the discharge cells 110. In the sustain period of each subfield, as shown in FIG. 2, the X electrode driver 400 repeatedly applies sustain pulses to the X electrodes X1 to Xn. The sustain pulses include a high-level voltage (voltage of Vs in FIG. 2) and a low-level voltage (0V in FIG. 2), which are alternating. In one embodiment, the number of the repeated sustain pulses represents the weight of the subfield.

The Y electrode driver 500 repeatedly applies sustain pulses to the Y electrodes Y1 to Yn. The sustain pulses applied to the Y electrodes alternate the sustain pulse applied to the X electrodes X1 to Xn. More specifically, a high-level voltage is applied to a Y electrode when a low-level voltage is applied to an X electrode. Then, the voltage difference between the respective X electrodes and the respective Y electrodes alternately becomes the Vs voltage and −Vs voltage. Accordingly, the sustain discharge is repeatedly generated a predetermined number of times in the turn-on cells.

As shown in FIG. 2, each sustain pulse further has a half-level of the Vs voltage, i.e., Vs/2 voltage during a period between the period of the high-level voltage and the period of the low-level voltage. More specifically, the potential of Y electrodes or X electrodes is maintained at about Vs/2 voltage for a moment while the potential of Y electrodes or X electrodes increases from the 0V voltage to the Vs voltage or while the potential decreases from the Vs voltage to the 0V voltage. In embodiments, the increase from the 0V voltage to the Vs/2 voltage or from the Vs/2 voltage to the high-level voltage is faster than the decrease from the Vs voltage to the Vs/2 voltage or from the Vs/2 voltage to the 0V voltage. Then, the potential may rapidly increase from the 0V voltage to the Vs voltage such that the sustain discharge may be stably generated and may be quickly repeated.

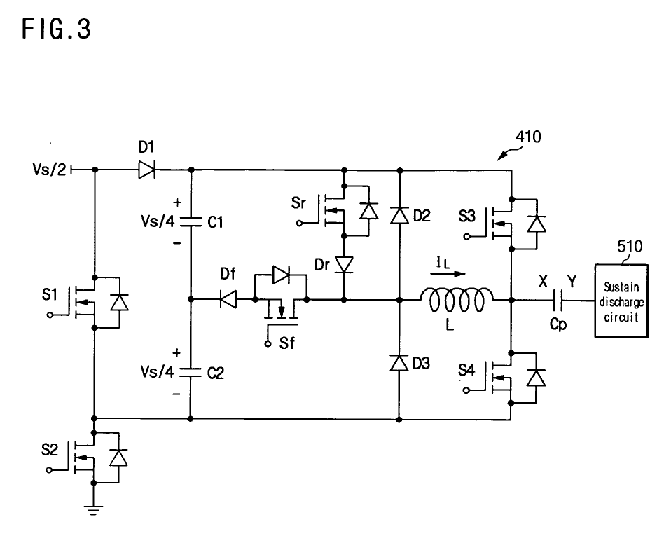

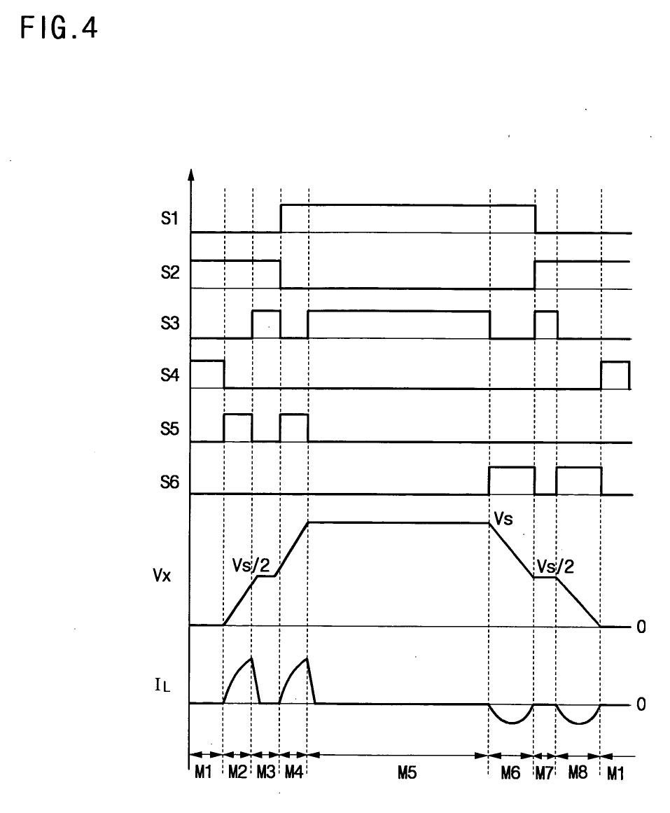

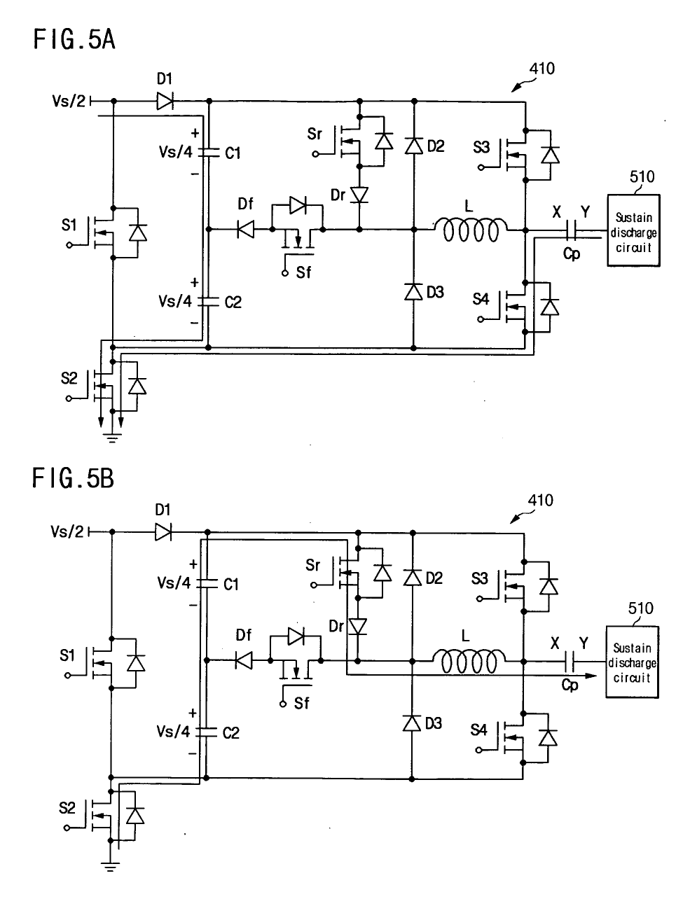

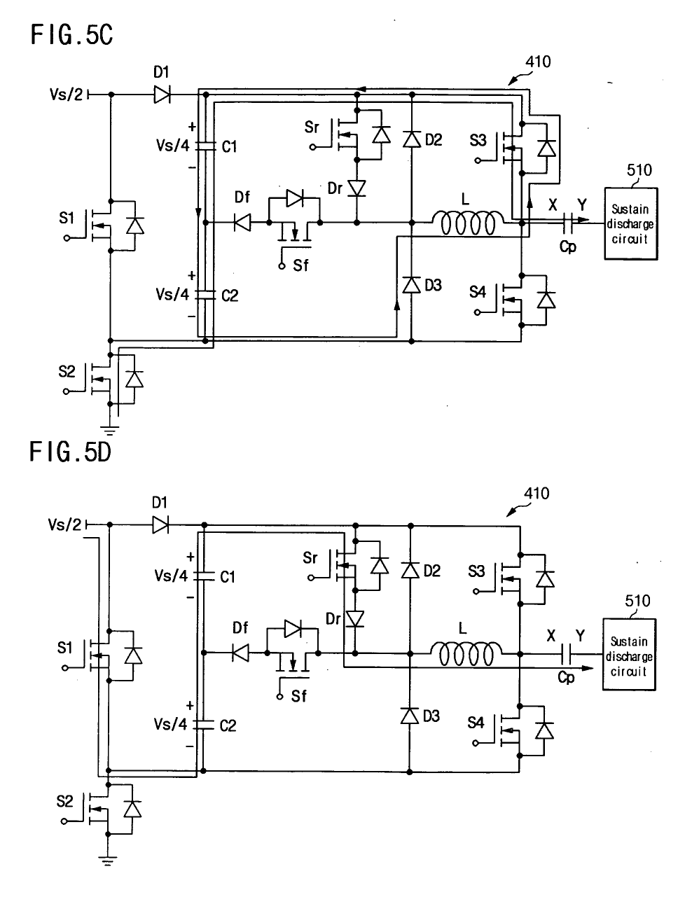

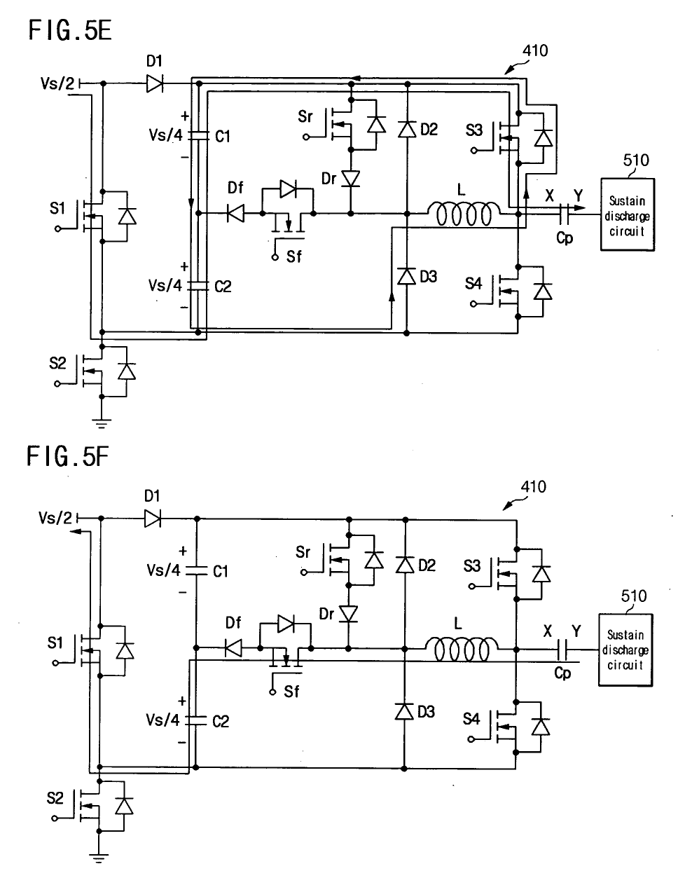

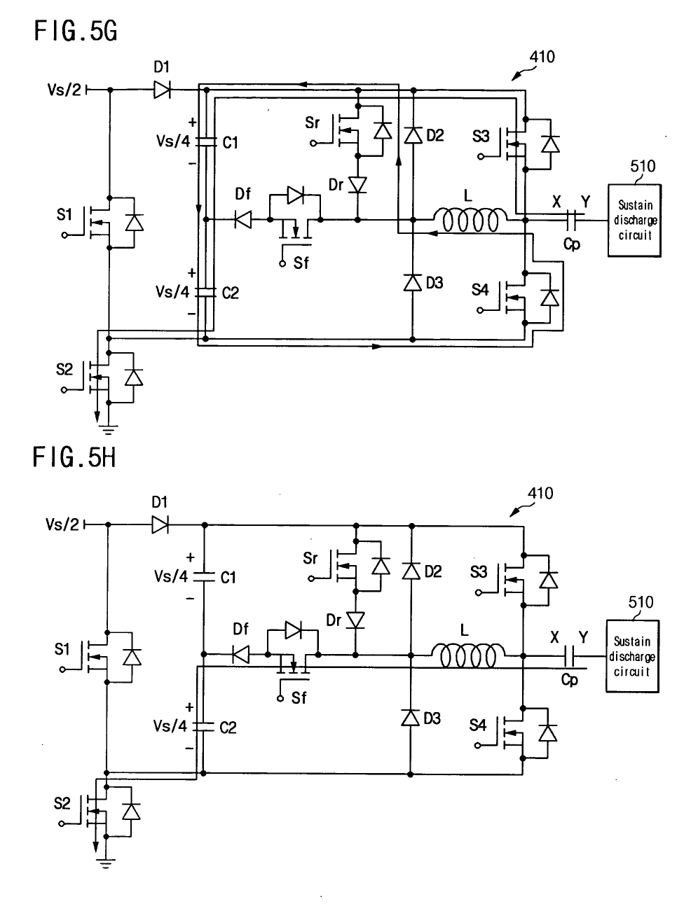

A sustain discharge circuit for supplying the sustain pulse of FIG. 2 will now be described in more detail with reference to FIG. 3, FIG. 4, and FIG. 5A to FIG. 5H. FIG. 3 is a schematic circuit diagram of a sustain discharge circuit 410 according to an embodiment of the present invention. Only a portion of the sustain discharge circuit 410 that is coupled to the X electrodes X1 to Xn is illustrated in FIG. 3. In one embodiment, the sustain discharge circuit 410 may be provided in the X electrode driver 400 of FIG. 1. In one embodiment a sustain discharge circuit 510 coupled to the electrodes Y1 to Yn may have the same structure of the sustain discharge circuit 410 of FIG. 3. In another embodiment, the sustain discharge circuit 510 may have a different structure from the sustain discharge circuit 410 of FIG. 3.

In one embodiment, the sustain discharge circuit 410 may be commonly coupled to the X electrodes X1 to Xn. In another embodiment, at least two sustain discharge circuits 410 may be provided in the X electrode driver 400, the X electrodes X1 to Xn may be divided into at least two groups, and the at least two sustain discharge circuits 410 may be respectively coupled to the at least two groups. For ease of description, it is described in FIG. 3 that one X electrode and one Y electrode are coupled to the sustain discharge circuit 410 and that a capacitance formed by the X and Y electrodes is illustrated as a panel capacitor Cp.

As shown in FIG. 3, the sustain discharge circuit 410 includes transistors S1, S2, S3, S4, Sr, and Sf, diodes D1, D2, D3, Dr, and Df, an inductor L, and capacitors C1 and C2. The transistors operate as switches. In FIG. 3, the switches S1 to S4, Sr, and Sf are illustrated as n-channel field effect transistors, and particularly as n-channel metal oxide semiconductor (NMOS) transistors, and a body diode is formed in a direction from a source to a drain of each transistor S1 to S4, Sr, and Sf.

In one embodiment, another transistor performing a similar function to that of the NMOS transistor may be used for each of the transistors S1 to S4, Sr, and Sf instead of the NMOS transistor. In one embodiment, each of transistors S1 to S4, Sr, and Sf may be provided as a plurality of transistors coupled in parallel or a plurality of transistors coupled in series.

As shown in FIG. 3, a drain of the transistor S1 is coupled to a power source Vs/2 that supplies the Vs/2 voltage which corresponds to half the sum of the high-level voltage (Vs voltage) and the low-level voltage (0V) of the sustain pulse. In one embodiment, the Vs/2 voltage may be supplied from a capacitor formed in a switching mode power supply (SMPS) (not shown).

The source of the transistor S1 is coupled to the drain of the transistor S2, and the source of the transistor S2 is coupled to a power source for supplying the low-level voltage. That is, the source of the transistor S2 is coupled to a ground terminal for supplying a ground voltage, 0V.

A first end of the capacitor C2 is coupled to the source of the transistor S1 and the drain of the transistor C2. A second end of the capacitor C2 is coupled to a first end of the capacitor C1. The cathode of the diode D1 is coupled to a second end of the capacitor C1. The anode of the diode D1 is coupled to the power source Vs/2. Herein, the diode D1 forms a charge path for charging the capacitors C1 and C2 with the voltage Vs/2 when the transistor S2 is turned on. Since the capacitors C1 and C2 have substantially the same capacitance, each of the capacitors C1 and C2 is charged with a quarter of the Vs voltage, i.e., Vs/4 voltage. In one embodiment, another element (e.g., transistor) which is capable of forming the charging path may used instead of the diode D1.

The transistors S1 and S2 are operated as a circuit for selectively applying the Vs/2 voltage or 0V voltage to the first end of the capacitor C2. That it, the first end of the capacitor C2 is selectively coupled to the power source Vs/2 and the ground terminal.

The source of the transistor S3, the drain of the transistor S4, and a first end of the inductor L are coupled to the X electrode. The drain of the transistor S3 is coupled to the second end of the capacitor C1. The source of the transistor S4 is coupled to the common node of the transistors S1 and S2 and the capacitor C2. The drain of the transistor Sf is coupled to a second end of the inductor L. The anode of the diode Df is coupled to the source of the transistor Sf. The cathode of the diode Df is coupled to the second end of the capacitor C2. The drain of the transistor Sr is coupled to the second end of the capacitor C1. The anode of the diode Dr is coupled to the source of the transistor Sr. The cathode of the diode Dr is coupled to the second end of the inductor L.

Herein, the diode Df blocks current which would flow through the body diode of the transistor Sf if the transistor Sf is turned off. The diode Dr blocks current which would flow through a body diode of the transistor Sr when the transistor Sr is turned off. In one embodiment, the diode Df or Dr may not be used in the sustain discharge circuit 410 if the transistor Sf or Sr does not have the body diode. Then anode and cathode of the diode D2 are respectively coupled to the second end of the inductor L and the second end of the capacitor C1. The anode and cathode of the diode D3 are respectively coupled to the first end of the capacitor C2 and the second end of the inductor L. The diodes D2 and D3 respectively forms current paths for recovering residual energy of the inductor L to the capacitors C1 and C2 by free wheeling the residual current in the inductor L.

An operation of the sustain discharge circuit 410 of FIG. 3 will be described in more detail with reference to FIG. 4, and FIG. 5A to FIG. 5H. FIG. 4 is a signal timing diagram of the sustain discharge circuit 410 according to the embodiment of FIG. 3. FIG. 5A to FIG. 5H respectively show operations of the sustain discharge circuit 410 of FIG. 3 according to the signal timing of FIG. 4.

Referring to FIG. 4 and FIG. 5A, the transistors S2 and S4 are turned on in a first mode M1 such that 0V is applied to the X electrode through a path formed from the X electrode through the transistor S4 and the transistor S1 to the ground terminal. Also, the capacitors C1 and C2 are respectively charged with the Vs/4 voltage through a path formed from the power source Vs/2 through the diode D1, the capacitors C1 and C2, and the transistor S2 to the ground terminal. At this state, the source voltage of the respective transistors S1 and S3 is about 0V, and the drain voltage of the respective transistors S1 and S3 is about the half of the Vs/2 voltage. Therefore, the voltage between the drain and the source of the turned-off transistors S1 and S3 is about the Vs/2 voltage.

In a second mode M2 of FIG. 4, the transistor S4 is turned off and the transistor Sr is turned on while the transistor S2 is turned on. Accordingly, a resonance path is formed from the ground terminal through the transistor S2, the capacitors C2 and C1, the transistor Sr, the diode Dr, and the inductor L to the panel capacitor Cp, as shown in FIG. 5B. Then the energy charged to the capacitors C1 and C2 is supplied to the X electrode through the inductor L by the resonance, such that the potential Vx of the X electrode is increased from 0V to the Vs/2 voltage. Since the capacitors C1 and C2 are coupled in series so as to operate a power source supplying the Vs/2 voltage, the potential Vx of the X electrode may increase to the Vs/2 voltage during about a quarter of a resonance cycle when there is no parasitic component in the sustain discharge circuit 410.

Accordingly, the potential Vx of the X electrode can be rapidly increased to the Vs/2 voltage. Generally, the potential Vx of the X electrode can be increased to the Vs voltage during a half of the resonance cycle in the case that parasitic component does not exist in the sustain discharge circuit 410. Therefore, the potential Vx of the X electrode can be increased to a voltage which is the same as or higher than the Vs/2 voltage although the parasitic components exist in the sustain discharge circuit 410. However, the potential Vx of the X electrode may be clamped to the Vs/2 voltage by the body diode of the transistor S3 even though the potential Vx of the X electrode increases higher than the Vs/2 voltage.

In a third mode M3 of FIG. 4, the transistor S3 is turned on and the transistor Sr is turned off while the transistor S2 is turned on. Accordingly, the half of the Vs voltage is applied to the X electrode through a path formed from the ground terminal through the transistor S2, the capacitors C2 and C1 to the transistor S3 as shown in FIG. 5C since the capacitors C1 and C2 are serially coupled so as to operate as a power source supplying the Vs2/voltage, the potential of the X electrode is maintained at about the Vs/2 voltage.

In addition, since the transistor S3 is turned on at a state that the potential Vx of the X electrode is the Vs/2 voltage, the transistor S3 can be soft-switched. Furthermore, the inductor retains residual current (energy) I_{L} after the second mode 2 M2 as shown in FIG. 4. The residual current I_{L} is free-wheeled through the body diode of the transistor S3, the capacitors C1 and C2, and the diode D3 so as to be recovered to the capacitors C1 and C2. At this state, the drain voltage of the respective transistors S1 and S4 is about 0V and the source voltage of the respective transistors S1 and S4 is the Vs/2 voltage. Therefore, the voltage between the drain and the source of the turned-off transistors S1 and S4 is about the Vs/2 voltage.

In a fourth mode M4, the transistors S2 and S3 are turned off and the transistors S1 and Sr are turned on. Then, a resonance is generated in a path formed from the power source Vs/2 through the switch S1, the capacitors C2 and C1, the transistor Sr, the diode Dr, and the inductor L to the panel capacitor Cp, as shown in FIG. 5D. By the resonance, energy of the power source Vs/2 and energy stored at the capacitors C1 and C2 are supplied to the X electrode through the inductor L such that the voltage Vx of the X electrode increases from the Vs/2 voltage to the Vs voltage.

Since the power source Vs/2 is coupled to the first end of the capacitor C2 by the transistor S1, the power source Vs/2 and the capacitors C1 and C2 are operated as a power source supplying the Vs voltage. Accordingly, the potential Vx of the X electrode can be increased to the Vs voltage from the Vs/2 voltage during about a quarter of the resonance cycle if no parasitic component exists in the sustain discharge circuit 410. That is, the potential Vx of the X electrode can be rapidly increased to the Vs voltage.

Generally, the potential Vx of the X electrode can be increased to 3Vs/2 voltage during a half of the resonance cycle in the case that the parasitic component does not exist in the sustain discharge circuit 410. Therefore, the potential Vx of the X electrode can be increased to a voltage that is the same as or higher than the Vs voltage although the sustain discharge circuit 410 has the parasitic component. However, if the potential Vx of the X electrode is increased higher than the Vs voltage, the voltage Vx of the X electrode may be clamped to the Vs voltage by the body diode of the transistor S3.

In a fifth mode M5 of FIG. 4, the transistor S3 is turned on and the transistor Sr is turned off while the transistor S1 is turned on such that the Vs voltage is applied to the X electrode through a path formed from the power source Vs/2 through the transistor S1, the capacitors C2 and C1 to the transistor S3, as shown in FIG. 5E. The power source Vs/2 and the capacitors C1 and C2 are serially coupled so as to operated as a power source supplying the Vs voltage, and therefore the potential Vx of the X electrode is maintained at about the Vs voltage.

The transistor S3 can be soft-switched since the transistor S3 is turned on when the Vx potential of the X electrode is the Vs voltage. In addition, the inductor L retains residual current (energy) I_{L} after the fourth mode M4 as shown in FIG. 4. The residual current I_{L} is free-wheeled through the body diode of the transistor S3, the capacitors C1 and C2, and the diode D3 to be recovered to the capacitors C1 and C2.

At this state, the drain voltage of the transistor S2 and the source voltage of the transistor S4 are about the Vs/2 voltage, and the source voltage of the transistor S2 and the drain voltages of the transistor S4 are about the Vs voltage, the voltage between the drain and the source of the turned-off transistors S2 and S4 is about the Vs/2 voltage.

In a sixth mode M6, the transistor S3 is turned off and the transistor Sf is turned on while the transistor S1 is turned on such that a resonance is generated through a path formed from the panel capacitor Cp through the inductor L, the transistor Sf, the diode Df, the capacitor C2, and the transistor S1 to the power source Vs/2, as shown in FIG. 5F. This resonance causes the energy stored in the panel capacitor Cp to be recovered to the capacitor C2 and the power source Vs/2 through the inductor L, and thus the potential of the X electrode is decreased from the Vs voltage to the Vs/2 voltage.

Since the power source Vs/2 and the capacitor C2 are coupled in series so as to operate as a power source 3Vs/4 voltage, the potential Vx of the X electrode may be reduced to the Vs/2 voltage from the Vs voltage during about a half of the resonance cycle.

In a seventh mode M7, the transistors S2 and S3 are turned on and the transistors S1 and Sf are turned off, such that the Vs/2 voltage is applied to the X electrode through a path formed from the transistor S3 through the capacitors C1 and C2, and the transistor S2 to the ground terminal, as shown in FIG. 5G. Herein, since the capacitors C1 and C2 are serially coupled so as to operate as a power source supplying the Vs voltage, the potential Vx of the X electrode is maintained at about the Vs/2 voltage.

If the inductor L retains residual current (energy) I_{L} after the sixth mode M6 of FIG. 4, the residual current I_{L} is free-wheeled through the inductor L, the diode D2, the capacitors C1 and C2, and the body diode of the transistor S4 as shown in FIG. 5G. That is, the residual energy of the inductor L is recovered to the capacitors C1 and C2.

At this state, the drain voltage of the respective transistors S1 and S4 is about the V/2 voltage, and the source voltage of the respective transistors S1 and S4 is about the 0V voltage. Therefore, the voltage between the drain and the source of the turn-off transistors S1 and S4 is about the Vs/2 voltage.

In an eighth mode M8, the transistor S3 is turned off and the transistor Sf is turned on while the transistor S2 is turned on such that a resonance is generated through a path formed from the panel capacitor Cp through the inductor L, the transistor Sf, the diode Df, the capacitor C2, and the transistor S2 to the ground terminal, as shown in FIG. 5H. This resonance causes the energy stored in the panel capacitor Cp to be recovered to the capacitor C2 through the inductor L, and thus the potential Vx of the X electrode is decreased from the Vs/2 voltage to 0V. Since the capacitor C2 operates a power source supplying the Vs/4 voltage, the potential Vx of the X electrode is decreased to 0V during about a half of the resonance cycle.

The first through eighth modes M1-M8 may be repeated a number of times determined by the weight of the subfield such that the Vs voltage and 0V can be alternately applied to the X electrode. According to the illustrated embodiment, the potential Vx of the X electrode may rapidly increase to the Vs voltage to stably generate a sustain discharge since the potential Vx increases during about the quarter of the resonance cycle generated in the second mode M2 and the fourth mode M4. In addition, the energy recovery rate can increase since about the half of the resonance is used when the energy stored at the panel capacitor Cp is recovered to the capacitor C1 or C2, or the power source Vs/2 in the sixth mode M6 and the eighth mode M8. The sixth mode M6 and the eighth mode 8 are not involved in the generation of the sustain discharge.

According to the illustrated embodiment, the potential Vx of the X electrode increases from 0V to the Vs/2 voltage and then from the/2 Vs voltage to the Vs voltage. In addition, the potential Vx of the X electrode is reduced from the Vs voltage to the Vs/2 voltage and then to 0V. Therefore, electro-magnetic interference (EMI) can be reduced better than in the case where the potential Vx increases from 0V to the Vs voltage and then decreases from the Vs voltage to 0V directly.

In addition, as described in the first, third, fifth, and seventh modes M1, M3, M5, and M7, the voltage between the drain and the source of the transistors S1, S2, S3, and S4 is about the Vs/2 voltage when the transistors S1, S2, S3, and S4 are turned off. A transistor having the withstand voltage, which is about Vs/2 voltage, can be used as the respective transistors S1, S2, S3, and S4.

Furthermore, the sustain discharge circuit (510 of FIG. 2) applies 0V to the Y electrode while the Vs voltage is applied to the X electrode, and applies the Vs voltage to the Y electrode while 0V voltage is applied to the X electrode.

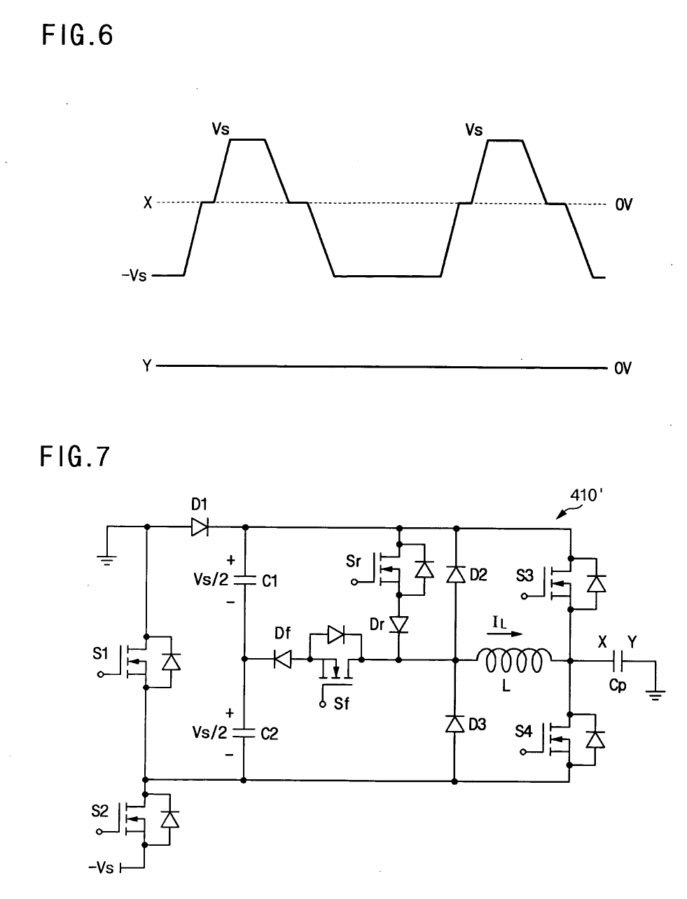

It is described that the sustain discharge pulse alternately having the high-level voltage and the low-level voltage is applied to the X electrode and the Y electrode in a reverse polarity according to the first exemplary embodiment of the present invention. However, the sustain pulse may be applied to one of the X electrode and the Y electrode, and this exemplary embodiment will now be described in detail with reference to FIG. 6 and FIG. 7.

FIG. 6 illustrates a sustain pulse according to another embodiment of the present invention, and FIG. 7 is a schematic circuit diagram of a sustain discharge circuit 410′ according to the embodiment of FIG. 6. As shown in FIG. 6, a sustain pulse alternately having the Vs voltage and −Vs voltage is applied to the plurality of X electrodes X1 to Xn, and 0V is applied to the plurality of Y electrodes Y1 to Yn during the sustain period according to the second exemplary embodiment of the present invention. While increasing from the −Vs voltage to the Vs voltage and decreasing from the Vs voltage to the −Vs voltage, the voltage of the X electrode is maintained at a middle voltage level (i.e., 0V) between the Vs voltage and the −Vs voltage for a predetermined period. Accordingly, the voltage difference between the X electrode and the Y electrode may alternately have the Vs voltage and the −Vs voltage, similar to the sustain pulse of FIG. 2.

Referring to FIG. 7, a sustain discharge circuit 410′ for the sustain pulses of FIG. 6 is the same as the sustain discharge circuit 410 of FIG. 3 except the voltages supplied from the power sources. More specifically, the drain of the transistor S1 is coupled to the ground terminal and the source of the transistor S2 is coupled to the power source −Vs that supplies the −Vs voltage. Therefore, the −Vs voltage and 0V may be selectively applied to a first end of the capacitor C2 by operation of the transistors S1 and S2. When the transistor S2 is turned on, the capacitors C1 and C2 are respectively charged with the/2 Vs voltage by the diode D1.

In this case, the voltage charged between the drain and source of a turned-off transistor is less than the half of the Vs voltage which corresponds to half of the voltage difference between the high level voltage (i.e., Vs voltage) and the low level voltage (i.e., −Vs voltage). Therefore, the sustain discharge circuit 410′ according to the second exemplary embodiment alternately applies the Vs voltage and the −Vs voltage to the X electrode, and the withstand voltage of the corresponding transistor may be relatively low.

It is illustrated in FIG. 6 and FIG. 7 that the sustain discharge circuit 410′ is coupled to the X electrode and the Y electrode is applied with 0V, but the sustain discharge circuit may be coupled to the Y electrode and the X electrode may be applied with 0V.

Also, when the source of the transistor S2 is coupled to the power source that supplies half of the −Vs voltage in the circuit of FIG. 7, the sustain pulse applied to the X electrode may alternately have the half of the Vs voltage and the half of the −Vs voltage. In this case, the sustain pulse applied to the Y electrode may be opposite to the sustain pulse applied to the X electrode.

According to the above-described exemplary embodiment of the present invention, a transistor having a relatively low withstand voltage is used, thereby reducing the cost of the sustain discharge circuit. In addition, electrodes can be promptly applied with a relatively high level voltage, and a transistor is soft-switched while applying the high level voltage to the electrodes.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A plasma display device comprising:
an electrode; and
a circuit for supplying voltages to the electrode, the circuit comprising:
a first capacitor comprising a first end and a second end,
a second capacitor comprising a first end and a second end, wherein the second end of the second capacitor is electrically connected to the first end of the first capacitor,
an inductor comprising a first end and a second end, wherein the first end of the inductor is electrically connected to the electrode,
a first switch electrically connected between the second end of the first capacitor and the second end of the inductor,
a second switch electrically connected between the second end of the second capacitor and the second end of the inductor,
a third switch electrically connected between the second end of the first capacitor and the electrode, and
a fourth switch electrically connected between the electrode and the first end of the second capacitor,
wherein the first end of the second capacitor is selectively connected to a first power source configured to supply a first voltage or a second power source configured to supply a second voltage.

2. The plasma display device of claim 1, wherein the circuit further comprises:
a fifth switch electrically connected between the first power source and the first end of the second capacitor; and
a sixth switch electrically connected between the second power source and the first end of the second capacitor;
wherein the circuit is configured to selectively form a charging path that electrically connects the first power source to the first end of the first capacitor, and is to charge the first and second capacitors.

3. The plasma display device of claim 2, wherein the charging path comprises a first diode having an anode electrically connected to the first power source and a cathode electrically connected to the second end of the first capacitor.

4. The plasma display device of claim 3, wherein each of the first switch and the second switch comprises a transistor having a body diode,
wherein the circuit further comprises a second diode serially connected to the first switch and a third diode serially connected to the second switch, and
wherein the second diode and the body diode of the first switch are connected in opposite directions, and the third diode and the body diode of the second switch are connected in opposite directions.

5. The plasma display device of claim 4, further comprising:
a fourth diode having an anode electrically connected to the second end of the inductor and a cathode electrically connected to the second end of the first capacitor; and
a fifth diode having a cathode electrically connected to the second end of the inductor and an anode electrically connected to the first end of the second capacitor.

6. The plasma display device of claim 2, further comprising a controller configured to cause to:
turn the fourth and sixth switches on during a first period,
turn the first and sixth switches on during a second period,
turn the third and sixth switches on during a third period,
turn the first and fifth switches on during a fourth period,
turn the third and fifth switches on during a fifth period,
turn the second and fifth switches on during a sixth period,
turn the third and sixth switches on during a seventh period, and
turn the second and sixth switches on during an eighth period.

7. The plasma display device of claim 1, wherein the first and second capacitors have substantially the same capacitance.

8. The plasma display device of claim 1, wherein the second voltage is a ground voltage, and wherein the first voltage is higher than the second voltage.

9. The plasma display device of claim 1, wherein the first voltage is a ground voltage, and wherein the second voltage is lower than the first voltage.

10. A method of driving a plasma display device, the method comprising:
providing a plasma display device comprising a first electrode, a second electrode, a first capacitor, a second capacitor and an inductor, wherein the second capacitor is serially connected to the first capacitor;
first increasing the potential of the first electrode from a first voltage to a second voltage;
first maintaining the potential at about the second voltage during a first period;
second increasing the potential from about the second voltage to a third voltage;
second maintaining the potential at about the third voltage during a second period;
decreasing the potential from about the third voltage to about the first voltage; and
third maintaining the potential at about the first voltage during a third period;
wherein first increasing comprises supplying energy stored in the first and second capacitors to the first electrode via the inductor;
wherein second increasing comprises supplying energy stored in the first and second capacitors to the first electrodes via the inductor;
wherein second increasing further comprises supplying energy from a power source to the first electrode via the inductor.

11. The method of claim 10, wherein decreasing comprises:
first decreasing the potential from about the third voltage to a fourth voltage;
fourth maintaining the potential at about the fourth voltage for during a fourth period; and
second decreasing the potential form about the fourth voltage to about the first voltage;
wherein first decreasing comprises releasing energy stored at the first electrode to a common node located between the first and second capacitors via the inductor and further to the power source via the inductor;
wherein second decreasing comprises releasing energy stored at the first electrode to the common node via the inductor.

12. The method of claim 11, further comprising charging the first and second capacitors using the power source during the third period.

13. The method of claim 11, wherein the inductor retains a first residual energy after first increasing and a second residual energy after second increasing,
wherein the method further comprises:
releasing the first residual energy to the first and second capacitors during the first period; and
releasing the second residual energy to the first and second capacitors during the second period.

14. The method of claim 11, further comprising:
maintaining the potential of the second electrode at about the first voltage during the second period; and
maintaining the potential of the second electrode at about the third voltage during the third period.

15. The method of claim 11, wherein the second voltage is substantially the same as the fourth voltage.

16. The method of claim 15, wherein the difference between the third voltage and the fourth voltage is about half of the difference between the third voltage and the first voltage.

17. The method of claim 10, further comprising repeating a sequence of actions, wherein the sequence comprises first increasing, first maintaining, second increasing, second maintaining, decreasing, and third maintaining.

18. An apparatus for driving a plasma display device having an electrode, the apparatus comprising:
an inductor configured to electrically connected to an electrode of a plasma display device;
a first capacitor;
a second capacitor serially connected to the first capacitor; and
circuits configured to selectively form a first path and a second path;
wherein the first path is to supply energy stored in the first and second capacitors to the electrode via the inductor so as to increase the potential of the electrode during a first period;
wherein the second path is to release energy from the electrode to a common node located between the first and second capacitors via the inductor so as to decrease the potential of the electrode for a second period following the first period.

19. The apparatus of claim 18, wherein the second capacitor comprises a first end and a second end,
wherein the second end of the second capacitor is connected to the common node,
wherein the circuits are further configured to selectively connect a first power source or a second power source to the first end of the second capacitor, and
wherein the first and second power sources are configured to supply different voltages.

20. A plasma display device comprising the apparatus of claim 18.
